(19) United States
(12) Patent Application Publication
(10) Pub. No.: US 2026/0222432 A1
(43) Pub. Date: Jul. 30, 2026

(54) METHODS AND APPARATUSES FOR DETECTING DATA-POISONING ATTACKS IN FEDERATED LEARNING ENVIRONMENT

(71) Applicant: Telefonaktiebolaget LM Ericsson (publ), Stockholm (SE)

(72) Inventors: Ömer Faruk TUNA, Istanbul (TR); Elif ÜSTÜNDAG SOYKAN, Maslak Istanbul (TR); Leyli KARAÇAY, Istanbul (TR); Ferhat KARAKOÇ, Istanbul (TR); Pinar ÇOMAK, Ankara (TR)

(73) Assignee: Telefonaktiebolaget LM Ericsson (publ), Stockholm (SE)

(21) Appl. No.: 19/146,920

(22) PCT Filed: Jan. 24, 2023
(86) PCT No.: PCT/TR2023/050055

§ 371 Date: Jul. 10, 2025

(51) Int. Cl. H04L 9/40; G06N 3/0455; G06N 3/098

(52) U.S. Cl. CPC H04L 63/1425; G06N 3/0455; G06N 3/098; H04L 63/1416

(57) ABSTRACT

In a first aspect of the present disclosure, there is presented a method performed by at least one client node for detecting data-poisoning attacks in a communication network. The method comprises obtaining, from a server node, an autoencoder, AE, model and a global machine learning, ML, model. The method further comprises training the AE model and the global ML model, by using local data of the client node. The method further comprises determining a first anomaly based on a first analysis on a latent space distribution matrix obtained from the training of the AE model. If the first anomaly is not determined, the method further comprises transmitting, to the server node, a result of the first analysis, an AE model update and a global ML model update.

### TECHNICAL FIELD

The present application relates to a method carried out by a client node and a method carried out by a server node, wherein both types of nodes are configured to detect security attacks in wireless communication systems, more particularly to detect data-poisoning attacks in Federated Learning (FL) environment. Furthermore, the corresponding client node and server node are provided. Additionally, a system comprising client nodes and the server node and a computer program product comprising computer program code are provided.

### BACKGROUND

Conventional machine learning (ML) algorithms need centralized (e.g., on a machine or a data center) training data. This centralization may not be desirable or even feasible, as it requires direct access to training data which is particularly problematic for privacy-sensitive activities. Federated learning (FL), also known as Federated Machine Learning, was introduced as a privacy-aware collaborative ML technique where high-quality models can be achieved without centralizing data.

In the setting of the technique, the participants are a server and clients. The server constructs a global ML model, while the clients help the construction of the model. The privacy enhancement in this technique is that the clients send some update parameters computed using their own (private, local) data, instead of sending their plain data to the server.

In FL, the server has no control over clients' behavior and their private data. There is no centralized authority to validate data. This makes the FL system vulnerable to data poisoning attacks where malicious clients or adversaries influence the clients' local training data (input) and/or labels defining the training data.

In FL, the clients' local data should be annotated by labeling. Since the server cannot access the data, it is important that the clients' local data are correctly labelled/annotated.

Label flipping attack is a special case of data-poisoning attack where the attackers are able to manipulate the labels assigned to the local training data. Due to the poisoned local dataset of the clients, the model training updates can negatively affect the quality of the aggregated global model. This label-flipping attack may cause a significant error rate in the global model, thus harming the performance of the FL system. In the absence of an effective detection system, the poisoned local model updates from malicious clients are not filtered, poisoning the global model.

According to adversarial goals of attackers, label-flipping attacks can be classified under two types of attacks, targeted attacks and untargeted attacks.

Targeted attacks, e.g., backdoor attacks, are those where attackers misguide the model to predict a particular incorrect class. In untargeted attacks, e.g., Byzantine attacks, attackers misguide the model to predict any incorrect class other than the true one.

Targeted attacks try to alter the behaviors of the model on some specific data instances chosen by the attackers, such as recognizing the images of rifles as turtles. So, the model performance is not affected for the other data instances in targeted attacks. Untargeted attacks try to undermine the overall model performance and result in model performance degradation or failure of model training.

In an FL setup, a deliberate mislabeling of all data samples of a certain class, e.g., flipping the labels with the labels of another class, can be regarded as the backdoor (targeted) attack. Whereas, interchanging the labels of data samples belonging to two different classes can be considered as the Byzantine (untargeted) attack.

To detect and mitigate poisoning attacks, there are some solutions based on the techniques of autoencoder (AE) and clustering.

AE is a neural network which compresses the input into a latent space and then reconstruct the output from this latent space. FIG. 1 illustrates the architecture of an AE model.

The latent space means a representation of compressed data. The AE model receives x as input data. An encoder compresses the input data into an encoded form of the latent space (bottleneck) which is often many orders of magnitude less. Since some information is lost during the compression, the latent space must represent only the most important features of the input data. Hence, the latent space representation is used to transform more complex forms of the input data into simpler representations which are more convenient to process and analyze. A decoder receives the information sampled from the latent space to produce (reconstruct) x′ as similar as possible to x, with reduced noise.

The construction of the latent space is an example of dimensionality reduction, as the dimensionality of the latent space is chosen to be lower than the dimensionality of the feature space from which the data points are drawn. The input data is often redundant with high dimensions. This not only challenges the computational efficiency but also hinders the modelling of the representation. The basic assumption behind the dimensionality reduction is that the high dimensional data has often a lower dimension embedding which is sufficient to represent the content of the original data. The relatively low (simple) dimensional latent space represents the complex feature space by approximating the real feature space of the input data. That is why the low dimensional latent space aims at capturing the most important features required to learn and represent the input data.

Since the process of the latent space representation of the input data is hidden from human intervention/understanding, the latent space is called hidden layer or bottleneck. The hidden layer is located between input and output of the algorithm, in which the function of the neural network applies weights to the inputs and directs them through an activation function as the output. In other words, the hidden layer performs nonlinear transformations of the inputs entered into the network and the outputs from the hidden layer are just raw data. What the neural network learns to do with this data, how they represent features, is hidden representation.

In view of the above, to perform well, the network must learn to extract the most relevant features in the latent space.

FIG. 2 illustrates a visualization of a trained AE latent space for Modified National Institute of Standards and Technology (MNIST) digits in 2-dimensions, 2d, using the t-distributed Stochastic Neighbor Embedding (t-SNE) technique. t-SNE is a technique to visualize multi-dimensional data in 2d representation, t-SNE1 and t-SNE2.

Samples of each class form a cluster representing the low dimensional representation of each class. Since each class has its own distinct features, the clusters of each class are separated in the latent space of the AE. In the example of FIG. 2, 4 clusters are represented with different geometric shapes.

That is why clustering, which is an ML technique of grouping data samples, is another technique used in existing solutions to detect and mitigate poisoning attacks in the literature. The clustering method can be used to classify each data sample into a certain class (group), given a set of data samples. Data samples in the same class should have comparable attributes and/or features, whereas data samples in other classes should have different features. Clustering is an unsupervised learning strategy that is widely utilized in various domains for statistical data analysis. There are several clustering algorithms that can be used to cluster given data points, such as k-means cluster, mean-shift or Density-Based Spatial Clustering of Applications with Noise (DBSCAN).

In view of the above, the methods of AE and clustering help capture the essential features of the data, reducing the computational complexity due to working on high dimensional space and hence making the analysis of complex data easier.

A paper by Razmi, Fereshteh et al. (2021) entitled: “Classification Auto-Encoder based Detector against Diverse Data Poisoning Attacks” proposes a Classification Autoencoder (CAE)-based detector that utilizes both feature space and label information to defend against diverse poisoned data. Authors train an AE on feature space as an outlier detection method and calculate the reconstruction error (RE) to detect poison in feature space. Any data with a large RE value can be considered poison. To capture poisons in a label (e.g., label-flipping), they propose an auxiliary classifier which is fed by the latent representation of the encoder and detects poisons, if the auxiliary classifier's loss on latent representation is greater than a threshold.

In Li, Suyi, et al. (2020), ordinary and malicious model updates are fed to a variational autoencoder (VAE) to get their latent vectors which are used in spectral anomaly detection.

In another solution by Li, Dongcheng, et al. (2021) authors propose a method to detect and mitigate label-flipping attacks in FL. They use Kernel Principal Component Analysis (KPCA) dimensionality reduction algorithm and k-means clustering to catch malicious model updates. KPCA is used to reduce the dimension of the model updates that may contain many irrelevant or redundant parameters. Then the k-means algorithm is used to group data points based on their similarity. Applying KPCA before clustering can improve the clustering results. The use of KPCA enables their method to handle both linear and nonlinear data.

However, the existing solutions suffer from drawbacks, such as computational complexity due to working on high dimensional space. Existing methods work on the model weight updates sent from clients to server. It is known that deep neural network (DNN) can be extremely large architectures with millions of weight parameters. Even if the dimensionality is tried to be reduced in the prior art, they are still prone to the curse of dimensionality concept which arises when analyzing data in high-dimensional spaces. When the dimensionality increases, the volume of the space increases so fast that the available data become sparse. To be able to obtain a reliable result, the amount of the needed data often grows exponentially with the dimensionality. Moreover, there is also problem in organizing and searching data which often relies on detecting areas where objects form groups with similar properties. In high dimensional data, all objects appear to be sparse and dissimilar in many ways, which prevents common data organization strategies from being efficient.

Against this background, there remains the need of a method to effectively and accurately detect data-poisoning, e.g., label-flipping, attacks in the FL environment.

### SUMMARY

Accordingly, an object of aspects and embodiments herein is to address the above issues.

In a first aspect of the present disclosure, there is presented a method performed by at least one client node for detecting data-poisoning attacks in a communication network. The method comprises obtaining, from a server node, an autoencoder, AE, model and a global machine learning, ML, model. The method further comprises training the AE model and the global ML model, by using local data of the client node. The method further comprises determining a first anomaly based on a first analysis on a latent space distribution matrix obtained from the training of the AE model. If the first anomaly is not determined, the method further comprises transmitting, to the server node, a result of the first analysis, an AE model update and a global ML model update.

In some embodiments for the determining the first anomaly, the method further comprises clustering on the latent space distribution matrix M, wherein the local data samples are classified into a number, c, of classes, wherein the local data samples in each class have comparable attributes and/or features. The method further comprises comparing the number, a, of the local data samples in each class with the number, c, of the local data samples in each cluster.

In a second aspect of the present disclosure, there is presented a method performed by a server node for detecting data-poisoning attacks in a communication network. The method comprises providing an autoencoder, AE, model and a global machine learning, ML, model, to the client nodes. The method comprises obtaining, from the client nodes where a first anomaly is not determined based on a first analysis on a latent space distribution matrix obtained from training of the AE model, a result of the first analysis, an AE model update and a global ML model update. The method comprises determining a second anomaly for any of the client nodes based on a second analysis on the result of the first analysis.

In some embodiments for the determining the second anomaly, the method further comprises comparing distributions of each vector of vϵR^{b} in the matrix VϵR^{c×b} for each class among the client nodes.

In a third aspect of the present disclosure, a client node for detecting data-poisoning attacks in a communication network is provided. The client node is configured to perform the method of the first aspect. The corresponding embodiments for the method disclosed above are also applicable for the client node.

In a fourth aspect of the present disclosure, a server node for detecting data-poisoning attacks in a communication network is provided. The server node is configured to perform the method of the second aspect. The corresponding embodiments for the method disclosed above are also applicable for the server node.

In a fifth aspect of the present disclosure, a computer program product for detecting data-poisoning attacks in a communication network is provided. The computer program product comprises program code portions that, when executed on at least one processing unit, configure the processing unit to perform the method of any one of the example implementations in accordance with the first or the second aspect. The computer program product may hereby, in some examples, be stored on a computer-readable storage medium or encoded in a data signal.

In a sixth aspect of the present disclosure, a system for detecting security attacks in IoS applications is provided. The system comprises any combination of client nodes according to the third aspect and at least one server node according to the fourth aspect.

Advantageously these aspects provide an effective and accurate detection of data-poisoning (label-flipping) attacks, both the backdoor (targeted) and the Byzantine (untargeted) attacks, in the FL environment.

While doing so, these aspects advantageously introduce only a negligible amount of extra communication cost and computation overhead.

### BRIEF DESCRIPTION OF THE DRAWINGS

For a better understanding of the inventive concept, and to show how it may be put into effect, reference will now be made, by way of exemplary embodiments, to the accompanying drawings. In these drawings:

FIG. 1 shows a schematic illustration of an exemplary architecture of an AE model;

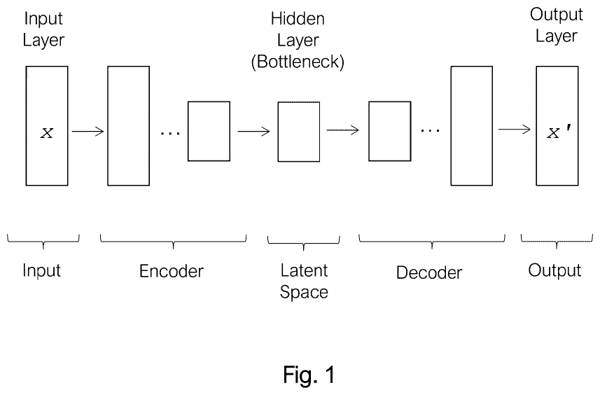

FIG. 2 shows a visualization of a trained AE latent space for MNIST digits in 2 dimensions using t-SNE technique;

FIG. 3 shows a schematic illustration of an exemplary FL system with an FL server node and K client nodes;

FIG. 4 shows a flow diagram of the method steps performed by the client node, according to the first aspect;

FIG. 4.1 shows a flow diagram of the further method steps performed by the client node, according to the first aspect;

FIG. 5 shows a flow diagram of the method steps performed by the server node, according to the second aspect;

FIG. 5.1 shows a flow diagram of the further method steps performed by the server node, according to the second aspect;

FIG. 6 shows a signalling diagram of the method steps performed by the server node and the K client nodes;

FIG. 7 shows schematic architectural view (in terms of functional units) of the client node and the server node;

FIGS. 8 and 9 show schematic illustrations (in terms of functional modules) of the client node and the server node, respectively.

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments.

Those skilled in the art will appreciate that the examples outlined herein may be implemented using individual hardware circuits, using software functioning in conjunction with a programmed microprocessor or general-purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by the one or more processors. Like numbers refer to like elements throughout the description. Any step or feature illustrated by dashed/dotted lines should be regarded as optional.

Before going into details of the embodiments, first of all, a known FL system 100 and a related FL process will be described below.

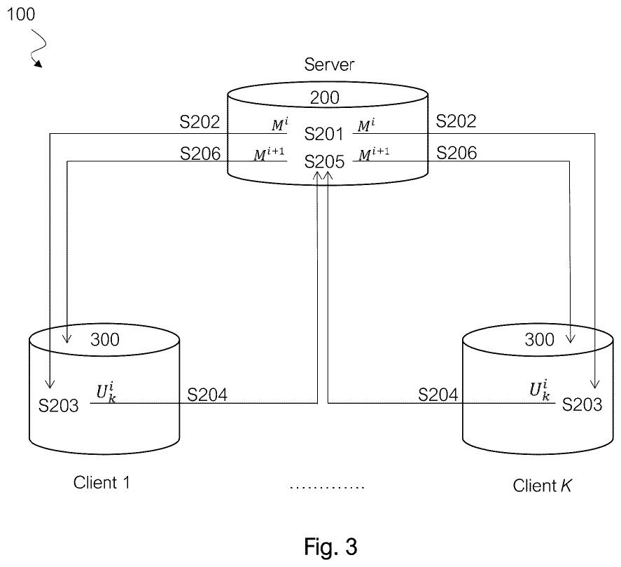

FIG. 3 illustrates a known FL system 100 and the related FL process S201-S206 where embodiments presented herein can be applied. The system 100 comprises an FL server node 200 and K client nodes 300.

S201: The central server node 200 constructs S201 an initial global ML model, Mⁱ.

S202: Each of K federated clients download S202 the initial global ML model, Mⁱ, and a training setting from the server node 200.

S203: Based on the training setting, each client node 300 trains S203 the initial global model, Mⁱ, with its local data for E rounds and then computes an update,

$${U}_{k}^{i} ,$$

of Mⁱ. Herein i denotes the number of training rounds, where iϵ{1, 2, . . . E} and k denotes the number of client nodes, where kϵ{1, 2, . . . , K}.

S204: The updates

$${U}^{i} = \{ {U}_{1}^{i} , {U}_{2}^{i} , ... , {U}_{K}^{i} \} ,$$

iϵ{1, 2, . . . , E}, are sent S204 by the K client nodes 300 to the server node 200.

S205: The server node 200 updates S205 the initial global model, Mⁱ, based on the aggregation of the collected updates, Uⁱ.

S206: Thereby an updated global model, Mⁱ⁺¹, is obtained to be downloaded S206 for the next training round.

This process S201-S206 is repeated until the global model converges, e.g., when the global model does show only minor or no change anymore compared to different rounds of FL or until a termination criterion, e.g., a pre-determined number of rounds, is met.

As noted in the Background section, there is still a need for an improved protection against data-poisoning attacks.

The embodiments disclosed herein therefore relate to techniques for effectively and accurately detecting data-poisoning, e.g., label-flipping, attacks in the FL environment. In order to realize such techniques, there is provided a client node 300; a server node 200; methods performed by at least one client node 300 and the server node 200; computer program products comprising codes that when run on the client node 300 and the server node 200, causes them to perform the methods; and a system 100 comprising client nodes 300 and at least one server node 200. It will be appreciated that the members 200, 300 of the system 100 are not limited to any particular number of nodes, devices or entities.

The embodiments disclosed herein work for both types of label-flipping attacks, the backdoor (targeted) and the Byzantine (untargeted) attacks.

The techniques by the client node 300 prevent the backdoor-type label-flipping attacks, where the adversary needs to flip the labels, belonging to a certain class, to another (target) class to make a prediction to the target class.

The techniques by the server node 200 prevent the Byzantine-type label flipping attacks, where the adversary needs to cause a deviation of the latent space distribution vectors among available classes.

According to example implementations outlined throughout the present disclosure, efficacy and accuracy in detecting data-poisoning attacks is improved. False positives and/or false negatives when detecting attacks may be reduced in example implementations outlined herein when compared to methods according to the state of the art.

Methods for detecting data-poisoning attacks are necessary, despite of additional, but negligible, communication cost and computation overhead when compared to the known FL system. The approach herein is based on the latent space distribution of local input dataset rather than the original DNN model architecture itself, e.g., the dimensions of the latent space matrix is small compared to the model weight updates. Hence, the approach adds negligible amount of extra communication cost and computation overhead to the standard FL setting.

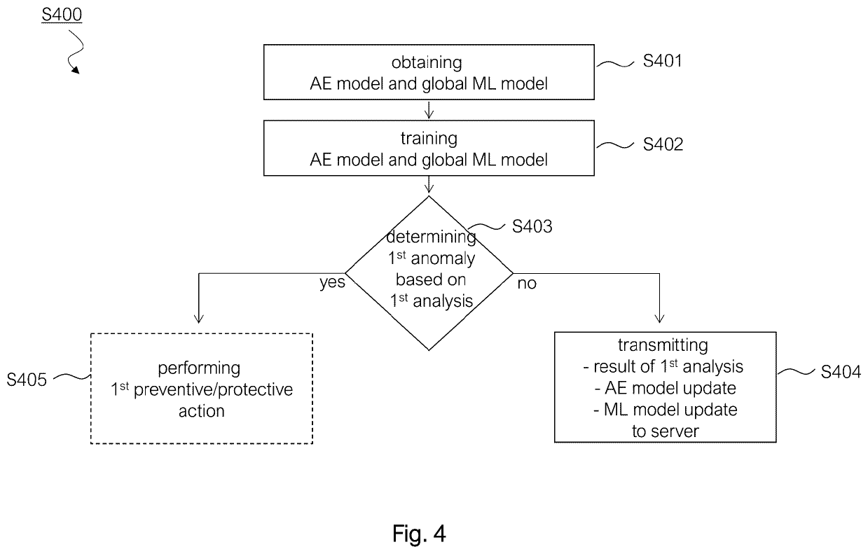

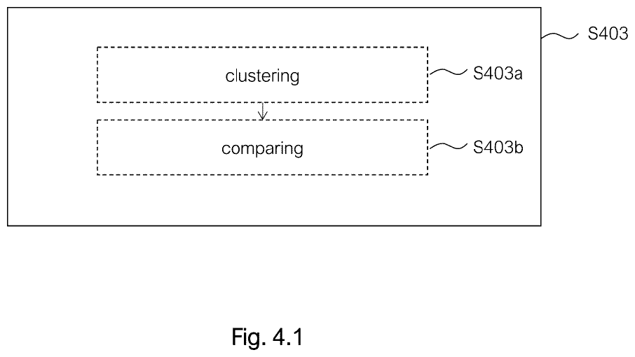

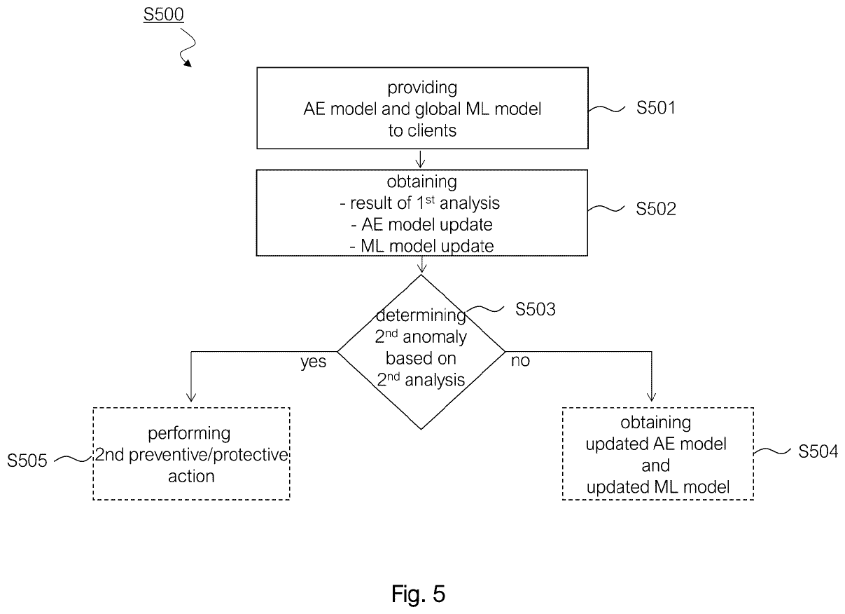

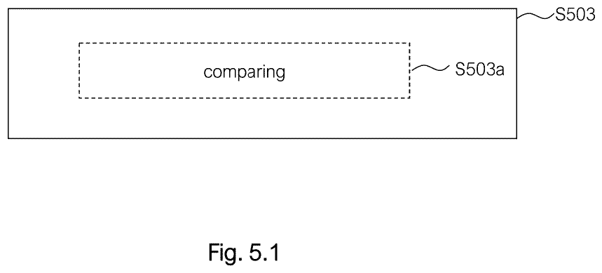

Details of how methods S400, S500 for detecting data-poisoning attacks are performed will be disclosed in reference to FIG. 4 and FIG. 5 below.

Reference is first made to FIG. 4 which illustrates the steps of method S400 performed by the client node 300, according to the first aspect, for detecting data-poisoning attacks in a communication network.

S401: The client node 300 obtains, from the server node 200, an AE model and a global ML model.

The AE model and the global ML model may be a neural network. It will be understood that other ML models may also be employed interchangeably (additionally, alternatively) or simultaneously (concurrently).

Under the inventive concept, the AE model will be serving as an additional tool to do analysis in the later steps, thanks to the nature of compressing input into a latent space representation and then reconstructing the output from this representation.

S402: The client node 300 trains the AE model and the global ML model, by using its own local data.

Training data used for the training of the AE model and the global ML model comprise input data points (x) and their associated labels (y), commonly referred as (x,y) pairs. The global ML model is a DNN architecture trained for the purpose of classification of input data points. Parameters related with the global ML model are the weights or biases of the DNN architecture.

S403: The client node 300 determines a first anomaly based on a first analysis on a latent space distribution matrix, M, which is obtained from the training of the AE model.

In general, the term “determine or determining” used in the present context may include “calculating/computing by the client node 300, obtaining, receiving from another entity/node or actively retrieving the required piece of information from another entity/node or storage place”.

Anomaly is an abnormal behavior or a suspicious activity in the communication network that might end up compromising network operations through hidden infections, data theft, or other malicious activities.

At a high level, according to the herein disclosed embodiments, the latent space distribution matrix, M, which represents the most important features of the local data, is analyzed to determine whether the latent space distribution matrix, M, according to some criterion, appears to be suspicious.

In reference to FIG. 4.1., embodiments relating to further details of how the determining S403 the first anomaly is performed will be disclosed below.

The latent space distribution matrix is MϵR^{a×b}. Herein, a is the number of local data samples and b is latent space dimension.

S403a: The client node 300 clusters on the latent space distribution matrix, M. The local data samples are classified into a number, c, of classes. The local data samples in each class have comparable attributes and/or features.

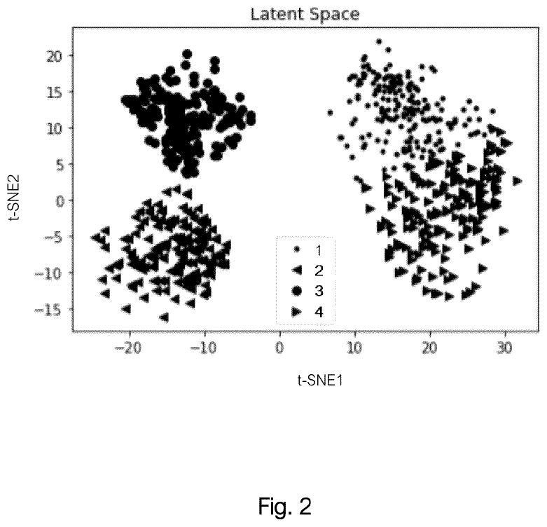

As can be seen from FIG. 2, which is a sample 2d representation for the latent space distribution of an AE trained on MNIST dataset, data points for each class form a cluster in latent space as they share similar characteristics.

Each client node 300 in FL setting has its own local dataset. Samples in the local dataset, including data and their associated labels, can be considered as any record in any dataset where we have values for the existing features. When the clustering is applied on the latent representation of the data itself, we have couple of these samples in each cluster. Normally, without any malicious activity such as poisoning labels of client data, it is expected to see equal number of local data samples in each class and local data samples in each cluster.

So, for the latent space of a well-trained AE, the data points belonging to each class form a cluster and can be clearly visualized. Assuming that we have c classes in a local dataset, we would expect to see c distinct clusters in the latent space of a trained AE. By applying known clustering algorithms on the latent space distribution matrix, M, of the local input dataset of each client, we roughly get the number of datapoints belonging to each class. And since each client also knows the exact number of data points for each class from their associated label information, we then have a chance to compare them and understand if the labels are flipped or not.

Hence, in its simplest form, the clustering S403a helps better in the next step of comparing S403b to (determine S403 the first anomaly) determine whether the suspicious latent space distribution matrix represents a deviation from the latent space distribution matrix observed in benign executions, e.g., the latent space distribution matrix which are known not to be affected by any attacks.

S403b: The client node 300 then compares the number, a, of the local data samples in each class with the number, c, of the local data samples in each cluster.

The first anomaly is determined, if a difference in the comparing S403b is more than a pre-defined value.

In some embodiments, the pre-defined value can be defined based on a set of the number of the local data samples in each class and a set of the number of the local data samples in each cluster. Both sets are obtained from a first anomaly detection model trained in a benign FL environment which is known not to be affected by any attacks.

The first anomaly detection model may be a neural network. But it will be understood that other ML models may generally be employed. The first anomaly detection model may also be a statistical model, e.g., a classification model trained both in a benign and malicious FL environment.

S404: If the client node 300 does not determine the first anomaly, it transmits a result of the first analysis, an AE model update and a global ML model update, to the server node 200.

The result of the first analysis is a matrix VϵR^{c×b}. A vector of vϵR^{b} for each class is obtained by averaging latent space vectors of each cluster. Herein, each vector of vϵR^{c} represents the latent space distribution for each class.

The result of the first analysis is transmitted S404 to the server node 200 to be used in a further (second) analysis under the general inventive concept. This part will be detailed later in the description where the steps of method performed by the server node 200 are disclosed.

The AE model update and the global ML model update are transmitted S404 to the server node 200 to be aggregated with other AE and global ML updates, respectively, coming from other client nodes 300 based on the further (second) analysis, whether a second anomaly is determined or not. These parts will be detailed later in the description where the method S500 steps performed by the server node 200 are disclosed.

S405: If the client node 300 determines the first anomaly, it performs S405 at least one first preventive and/or protective action to countermeasure the offending process.

Non-limiting examples of the at least one first preventive and/or protective action are not transmitting the result of the first analysis, the AE model update and the global ML model update, to the server node 200; issuing an alarm to make the client node 300 aware of the first anomaly about the training data; taking a snapshot of the system 100 (as a backup and/or for a post-mortem analysis); and issuing a report of the determined first anomaly to an operator of the system 100.

To increase the security, the method steps defined above can be performed by a Trusted Execution Environment, TEE, 301 located at the client node 300.

The TEE 301 is a hardware-based encryption technique, enabling system memory to be split into private, hardware-encrypted areas, called enclaves. In enclaves, sensitive data can be processed without the risk of it being exposed.

Under the inventive concept, the client node 300 share more information than in the usual FL setting, hence, reducing the privacy idea of FL. So, to increase the privacy, e.g., to prevent leakage from sharing additional information (the local model updates and the result of the first analysis), it will be appreciated that some privacy enhancing methods can be deployed.

It will also be appreciated that the method S400 steps above are advantageously provided as computer program.

Reference is now made to a flow diagram of FIG. 5 which illustrates the steps of method S500 performed by the server node 200, according to the second aspect, for detecting data-poisoning attacks in a communication network.

The method S500 performed by the server node 200, according to the second aspect, may be complementary to the method S400 performed by the client node 300, according to the first aspect.

S501: The server node 200 provides an autoencoder, AE, model and a global machine learning, ML, model, to the client node 300, where the AE model and the global ML model are trained S402 by using local data of the client node 300.

S502: The server node 200 obtains, from the client nodes 300 where a first anomaly is not determined based on a first analysis on a latent space distribution matrix obtained from training of the AE model, a result of the first analysis, an AE model update and a global ML model update.

Details on what is the latent space distribution matrix, how the first anomaly is determined or not and what is the result of the first analysis are described above.

S503: The server node 200 determines a second anomaly for any of the client nodes 300 based on a second analysis on the result of the first analysis.

In reference to FIG. 5.1., embodiments relating to further details of how the determining S503 the second anomaly is performed will be disclosed below.

S503a: The server node 200 compares distributions of each vector of vϵR^{b} in the matrix VϵR^{c×b} for each class among the client nodes 300 where a first anomaly is not determined.

In the absence of any label-flipping attacks, it is expected that the distribution of vectors of vϵR^{b} in the matrix VϵR^{c×b} for each class share a similar distribution, as each client node 300 uses the same AE model provided S501.

The server node 200 determines S503 the second anomaly for any of the client nodes 300 where a deviation in the comparing S503a is observed.

The deviation can be observed by using deviation metrics, like cosine similarity. Deviation metrics calculate the distance or similarity between two vectors, helping us understand the relationship between different vectors and data in them.

In some embodiments, formulation for cosine similarity metric for any two vectors A and B of dimensions b (Aϵ [symbol] , Bϵ [symbol] ) can be calculated as:

$$cos ( θ ) = \frac{A \cdot B}{‖ A ‖ ‖ B ‖} = \frac{{\sum }_{\text{?} = 1}^{\text{?}} {A}_{\text{?}} {B}_{\text{?}}}{\sqrt{{\sum }_{\text{?} = 1}^{\text{?}} {A}_{\text{?}}^{2} \cdot {\sum }_{\text{?} = 1}^{\text{?}} {B}_{\text{?}}^{2}}}$$

$$\text{?} \text{indicates text missing or illegible when filed}$$

S504: If the second anomaly is not determined, the server node 200 obtains an updated AE model by aggregating the AE model update with other AE model updates coming from other client nodes 300 when the second anomaly is not determined.

Similarly, the second anomaly is not determined, the server node 200 obtains S504 an updated global ML model by aggregating the global ML model update with other global ML model updates coming from other client nodes 300 where the second anomaly is not determined.

It will be appreciated that the server node 200 provides the obtained S504 updated AE and global ML models to the client nodes 300 to initiate a new FL round.

S505: If the server node 200 determines the second anomaly for any of the client nodes 300, it performs S505 at least one second preventive and/or protective action to countermeasure the offending process.

Non-limiting examples of the at least one second preventive and/or protective action are ignoring the AE model update and the global ML model update coming from the client node 300 where the second anomaly is determined; issuing an alarm to make aware of the second anomaly; taking a snapshot of the system 100; or issuing a report of the determined second anomaly to an operator of the system 100.

It will be appreciated that the method S500 steps above are advantageously provided as computer programs.

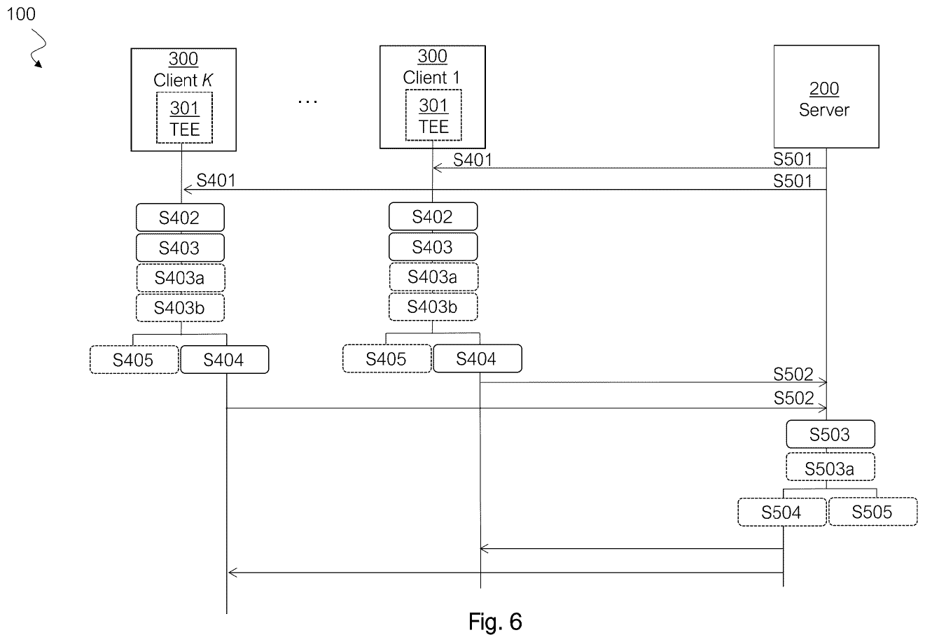

Reference is now made to a signaling diagram of FIG. 6 which illustrates an embodiment of a technique for detecting data-poisoning attacks in FL system 100 as performed by the server node 200 and the K client nodes 300.

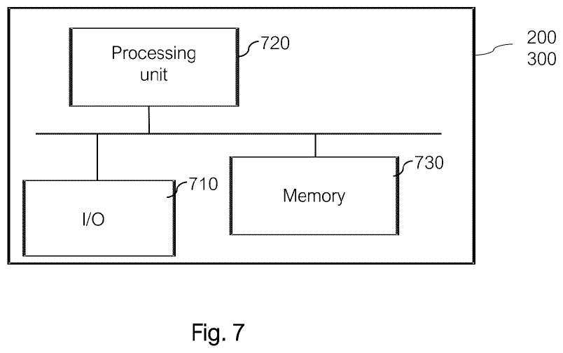

FIG. 7 shows, in terms of a number of functional units, a schematic architectural view of the client node 300 and the server node 200, which are involved in the steps discussed in connection with FIG. 6.

The client node 300 can be realized as a user equipment (UE), a mobile or portable station and/or any radio/wireless device to communicate wirelessly with network nodes and/or other wireless devices. Communicating wirelessly may involve transmitting and/or receiving wireless signals using electromagnetic waves, radio waves, infrared waves, and/or other types of signals suitable for conveying information through air.

The server node 200 can be realized as a respective standalone device or as a part of a device or a hardware (e.g., a radio device, a base station) or a software. Alternatively, functionality of the server node 200 may be distributed over different physical or virtual entities which may either be part of the same network part or may be spread between at least two such network parts. Thus, a part of the method steps performed by the server node 200 may be executed in a physical/virtual entity and another part of the method steps may be executed in another physical/virtual entity. The herein disclosed embodiments are not limited to any particular number of physical/virtual entities. Hence, the methods according to the herein disclosed embodiments are also suitable to be performed by the server node 200 residing in a cloud computational environment.

The client node 300 and the server node 200 comprise a communications interface (I/O) 710, which is provided for transmitting/receiving messages or any other data to/from other entities, network nodes and/or other wireless devices. As such the communications interface 710 may comprise one or more transmitters and receivers, comprising analogue and digital components. Furthermore, the client node 300 and the server node 200 comprise a processing unit 720 which is responsible for the operation of the client node 300 and the server node 200. The processing unit 720 can comprise one or more processors and can carry out instructions stored on a memory 730, wherein the memory may include a read-only memory, a random-access memory, a mass storage, a hard disk or the like or any other type of memory. The memory 730 can furthermore include suitable program code to be executed by the processing unit 720 so as to implement the above-described functionalities in which the client node 300 and the server node 200 are involved.

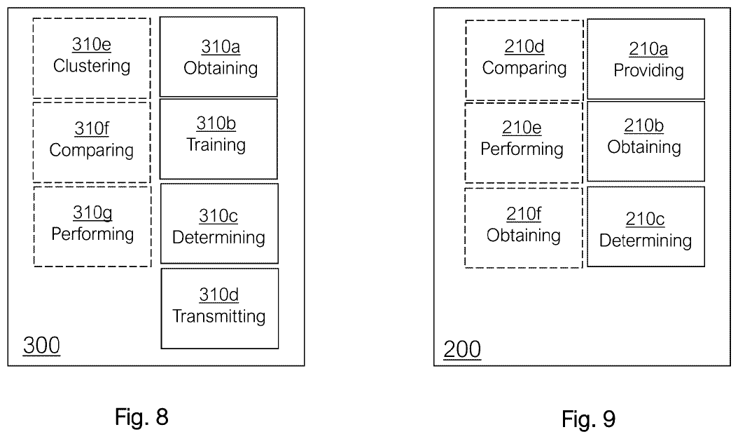

FIG. 8 schematically illustrates, in terms of a number of functional modules, the components of the client node 300 according to the third aspect. The client node 300 comprises the modules configured to perform the method of the first aspect.

The client node 300 of FIG. 8 comprises the functional modules of an obtaining module 310a configured to perform the obtaining S401; a training module 310b configured to perform the training S402; a determining module 310c configured to perform the determining S403 and a transmitting module 310d configured to perform the transmitting S404. The client node 300 of FIG. 8 may further comprise a number of optional functional modules, such as a clustering module 310e configured to perform the clustering S403a; a comparing module 310f configured to perform the comparing S403b or a performing module 310g configured to perform the performing S405. In general terms, each functional module 310a-310g may be implemented in hardware or in software. At least one of the functional modules of the client node 300 may be embedded in a single device or installed separately.

FIG. 9 schematically illustrates, in terms of a number of functional modules, the components of the server node 200 according to the fourth aspect. The server node 200 comprises the modules configured to perform the method of the second aspect.

The server node 200 of FIG. 9 comprises the functional modules of a providing module 210a configured to perform the providing S501; an obtaining module 210b configured to perform the obtaining S502 and a determining module 210c configured to perform the determining S503. The server node 200 of FIG. 9 may further comprise a number of optional functional modules, such as a comparing module 210d configured to perform the comparing S503a; a performing module 210e configured to perform the performing S505 or an obtaining module 210f configured to perform the obtaining S504. In general terms, each functional module 210a-210f may be implemented in hardware or in software. At least one of the functional modules of the server node 200 may be embedded in a single device or installed separately.

In view of the above, in some examples, an effective and accurate system 100 for detecting data-poisoning, e.g., label-flipping, attacks in the FL environment can be provided. The system 100 comprises any combination of the client nodes 300 according to the third aspect and the server node 200 according to the fourth aspect.

It will be appreciated that the examples and embodiments as explained above are merely illustrative and susceptible to various modifications. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

As such, the present invention is only limited by the claims that follow.

1. A method for detecting data-poisoning attacks in Federated Learning, FL, system comprising a server node and client nodes communicatively connected to the server node, the method performed by at least one client node and comprising:
from the server node, obtaining an autoencoder, AE, model and a global machine learning, ML, model;
training the AE model and the global ML model, by using local data of the client node;
determining a first anomaly based on a first analysis on a latent space distribution matrix, M, obtained from the training of the AE model; and
if the first anomaly is not determined, transmitting a result of the first analysis, an AE model update and a global ML model update, to the server node.

2. The method of claim 1, wherein the latent space distribution matrix is MϵR^{a×b}, wherein a is the number of local data samples and b is latent space dimension.

3. The method of claim 1, wherein the determining the first anomaly further comprising:
clustering on the latent space distribution matrix M, wherein the local data samples are classified into a number, c, of classes, wherein the local data samples in each class have comparable attributes or features; and
comparing the number, a, of the local data samples in each class with the number, c, of the local data samples in each cluster.

4. The method of claim 1, wherein the result of the first analysis is a matrix VϵR^{c×b}, wherein a vector of vϵR^{b} for each class is obtained by averaging latent space vectors of each cluster.

5. The method of claim 3, wherein the first anomaly is determined, if a difference in the comparing is greater than a pre-defined value.

6. The method of claim 5, further comprising:
performing at least one first preventive or protective action.

7. The method of claim 6, wherein the at least one first preventive or protective action pertains to at least one of:
not transmitting the result of the first analysis, the AE model update and the global ML model update, to the server node;
issuing an alarm to make aware of the first anomaly;
taking a snapshot of the system; or
issuing a report of the determined first anomaly to an operator of the system.

8. A method for detecting data-poisoning attacks in Federated Learning, FL, system comprising a server node and client nodes communicatively connected to the server node, the method performed by the server node and comprising:
providing an autoencoder, AE, model and a global machine learning, ML, model, to the client nodes;
from the client nodes where a first anomaly is not determined based on a first analysis on a latent space distribution matrix, M, obtained from training of the AE model, obtaining a result of the first analysis, an AE model update and a global ML model update; and
determining a second anomaly for any of the client nodes based on a second analysis on the result of the first analysis.

9. The method of claim 8, wherein the latent space distribution matrix is MϵR^{a×b}, wherein a is the number of local data samples and b is latent space dimension.

10. The method of claim 8, wherein the result of the first analysis is a matrix VϵR^{c×b}, wherein a vector of vϵR^{b} for each class is obtained by averaging latent space vectors of each cluster.

11. The method of claim 8, wherein the determining the second anomaly further comprising:
comparing distributions of each vector of vϵR^{b} in the matrix VϵR^{c×b} for each class among the client nodes.

12. The method of claim 11, wherein the second anomaly is determined for any of the client nodes where a deviation in the comparing is observed.

13. The method of claim 12, wherein the deviation can be observed by using deviation metrics.

14. The method of claim 13, further comprising:
performing at least one second preventive or protective action.

15. The method of claim 14, wherein the at least one second preventive or protective action pertains to at least one of:
ignoring the AE model update and the global ML model update;
issuing an alarm to make aware of the second anomaly;
taking a snapshot of the system; or
issuing a report of the determined second anomaly to an operator of the system.

16. The method of claim 8, further comprising:
if the second anomaly is not determined, obtaining an updated AE model by aggregating the AE model update with other AE model updates coming from other client nodes where the second anomaly is not determined; and
if the second anomaly is not determined, obtaining an updated global ML model by aggregating the global ML model update with other global ML model updates coming from other client nodes where the second anomaly is not determined.

17. A client node for detecting data-poisoning attacks in Federated Learning, FL, system comprising a server node and client nodes communicatively connected to the server node, configured to:
from the server node, obtain an autoencoder, AE, model and a global machine learning, ML, model;
train the AE model and the global ML model, by using local data of the client node;
determine a first anomaly based on a first analysis on a latent space distribution matrix obtained from the training of the AE model; and
if the first anomaly is not determined, transmit a result of the first analysis, an AE model update and a global ML model update, to the server node.

18-32. (canceled)

33. A computer program product comprising computer program code portions that, when executed on at least one processing unit, configure the processing unit to perform the method of claim 1.

34. A computer program product comprising computer program code portions that, when executed on at least one processing unit, configure the processing unit to perform the method of claim 8.

35. (canceled)

36. The method of claim 13, wherein the deviation metrics comprise cosine similarity.
